(19) United States
(12) Patent Application Publication
(10) Pub. No.: US 2015/0248808 A1
(43) Pub. Date: Sep. 3, 2015

(54) VIDEO WAGERING SYSTEM WITH MULTI-DIMENSIONAL CUBE ROTATION

(71) Applicant: James T. Crawford, III, Charlotte, MC (US)

(72) Inventor: James T. Crawford, III, Charlotte, MC (US)

(21) Appl. No.: 14/192,879

(22) Filed: Feb. 28, 2014

(51) Int. Cl. G07F 17/32

(52) U.S. Cl. CPC G07F 17/3213

(57) ABSTRACT

A gaming machine has a processor; a memory; player input controls; and an electronic display device displaying a wagering game. After a wager, the display device displays images from the memory of simulations of multiple symbols providing polyhedrons. Each polyhedron has axes of rotation about predetermined axes of revolution within the polyhedron. Memory provides stop positions for display of faces for forming paylines in games. Paylines include fully displayed faces and multiple faces simultaneously displayed at the stop position. The electronic display device displays from memory a simulated rotation about the axes of rotation according to:
c) a random selection by the processor of an axis of rotation for at least one symbol providing polyhedron or
d) player input control selected axis of rotation for the at least one symbol providing polyhedron

The processor resolves the wagers based upon comparison of the displayed simulations against a paytable.

### BACKGROUND OF THE INVENTION

1. Field of the Invention

The present invention relates to the field of electronic gaming, methods of providing paylines in virtual images provided in electronic video gaming systems and to gaming content provided in the novel payline structures provided in the virtual images.

2. Background of the Art

Published US Patent Application Document No. 20110053675 (Aoki) describes a gaming system and method allowing use of three dimensional objects in a wagering game. The three dimensional object includes multiple sides which are viewable by a player. Each of the multiple sides includes a symbol. An active payline contains one of the symbols. The symbols contained by the active payline are used to represent a randomly-determined result from the wagering game.

PCT Application WO 2012125131 A1 describes a method of delivering sponsor advertising content via sponsor-configured cube-centric games includes configuring a game template with sponsor advertising content to create a sponsor-specific cube-centric interactive game application, making at least one sponsor-specific cube-centric interactive game application available for download to user electronic devices and operating the at least one sponsor-specific cube-centric interactive game application in a electronic device during which users interact with a cube-centric graphical user interface (GUI) to play the game while the sponsor specific advertising content is delivered.

Published US Patent Application Document No. 20080234032 describes methods and systems allowing video slot machine players to wager on symbols occurring on all sides of a reel, including the reel's front, back, top, bottom, and inside portions. Players may move reels in space or on cubic structures to seek out winning paylines or win mystery bonuses on symbols combinations that occur on portions of the reel that may be initially hidden from their view.

Features of embodiments of the present invention allow players to increase the number of paylines on which they can bet by a factor of four or more.

U.S. Pat. No. 6,746,329 describes a method of displaying games related to slot machine games. The method: 1) using a three-dimensional structure as the basis of the display of the method with the primary plane of the three-dimensional structure as the center attraction of the screen of the electronic gaming device and the secondary planes around, 2) displaying the basic playing structure of the method on the primary plane, 3) allowing garners to place bets on the primary plane and on other secondary planes, 4) starting the method with the display of moving symbols on all the different planes of the three dimensional structure until they are stopped, and 5) awarding prizes to the methods in regard to the bets placed in the method on the planes of the three-dimensional structure, therefore in regard to the different represented paylines in three dimensions.

All references cited herein are incorporated by reference in their entirety.

### SUMMARY OF THE INVENTION

A gaming machine has a processor; a memory; player input controls; and an electronic display device displaying a wagering game. After a wager, the display device displays images from the memory of simulations of multiple symbols providing polyhedrons. Each polyhedron has axes of rotation about predetermined axes of revolution within the polyhedron. Memory provides stop positions for display of faces for forming paylines in games. Paylines include fully displayed faces and multiple faces simultaneously displayed at the stop position. The electronic display device displays from memory a simulated rotation about the axes of rotation according to:
a) a random selection by the processor of an axis of rotation for at least one symbol providing polyhedron or
b) player input control selected axis of rotation for the at least one symbol providing polyhedron

The processor resolves the wagers based upon comparison of the displayed simulations against a paytable.

### BRIEF DESCRIPTION OF THE FIGURES

FIG. 1 shows an example of a gaming machine that may used in the present technology.

FIG. 1A shows another gaming network that may be used to implement some aspects of the invention.

FIG. 1B illustrates an example of a network device that may be configured for implementing some methods of the present invention.

FIG. 2 shows a front view of a display screen image of nine cubes in an orientation wherein all three of the faces in only the far right column are in a same orientation. No other possible paylines have been formed by three same orientation faces.

FIG. 3 shows a perspective view of a cube with each corner labeled (as A, B, C, D, E, F, G and H) and symbols displayed on the three forward-looking faces of the cube.

FIG. 4 shows a perspective view of a cube with ten (as A, B, C, D, E, F, G, H, I and J) non-side axes of rotation displayed.

FIG. 5 shows a front view of a display screen image of three cubes in an orientation wherein all three of the faces are in a same orientation.

FIG. 6 shows a front view of a display screen image of three cubes in an orientation wherein all three of the faces are in different orientations with no available paylines according to some modalities of game play where only same orientations may form paylines.

### DETAILED DESCRIPTION OF THE INVENTION

A gaming machine has at least: a processor; a memory; player input controls; an electronic display device configured to display an at least first wagering game. The display device is configured to display, after recognition of a wager being placed through a player input control, images from the memory displaying simulations of multiple symbol providing polyhedrons. Each polyhedron has axes of rotation about an axis which might be a corner, a geometric center and/or each edge of each face or edge of the polyhedron. The memory provides stop positions for display of faces for forming paylines in a wagering game, the paylines including fully displayed faces and multiple faces simultaneously displayed at the stop position. The electronic display device may be configured to display from the memory a simulated rotation about the axes of rotation according to:
a) a random selection by the processor of an axis of rotation for at least one symbol providing polyhedron or
b) player input control selected axis of rotation for the at least one symbol providing polyhedron.

The processor is configured to resolve the recognized wager based upon comparison of the displayed simulations of multiple paylines provided along faces of the at least one symbol providing polyhedron against a paytable. The axes of rotation may be selected from axes that pass through a virtual geometric center of gravity of the polyhedron, from axes of rotation that are selected from axes that do not pass through a virtual geometric center of gravity of the polyhedron, from axes of rotation that pass through two corners of the polyhedron, from axes of rotation that pass through only one corner of the polyhedron. The gaming machine may have the polyhedron as any polyhedron, including a cube. Polyhedra are often named according to the number of faces. The naming system is again based on Classical Greek, for example tetrahedron (4), pentahedron (5), hexahedron (6), heptahedron (7), triacontahedron (30), and so on. Sometimes this is qualified by a description of the kinds of faces present, for example the rhombic dodecahedron vs. the pentagonal dodecacedron. Other common names indicate that some operation has been performed on a simpler polyhedron, for example the trunated cube looks like a cube with its corners cut off, and has 14 faces (so it is also an example of a tetrakaidecahedron or tetradecahedron).

In geometry, a polyhedron is traditionally a three-dimensional shape that is made up of a finite number of polygonal faces which are parts of planes; the faces meet in pairs along edges which are straight-line segments, and the edges meet in points called vertices. Cubes, prisms and Pyramids are examples of polyhedra. The polyhedron surrounds a bounded volume in three-dimensional space; sometimes this interior volume is considered to be part of the polyhedron, sometimes only the surface is considered, and occasionally only the skeleton of edges.

A polyhedron is said to be convex if its surface (comprising its faces, edges and vertices) does not intersect itself and the line segment joining any two points of the polyhedron is contained in the interior or surface.

Many of the most studied polyhedra are highly symmetrical. Of course it is easy to distort such polyhedra so they are no longer symmetrical. But where a polyhedral name is given, such as icosidodecahedron, the most symmetrical geometry is almost always implied, unless otherwise stated.

Some of the most common names in particular are often used with “regular” in front or implied because for each there are different types which have little in common except for having the same number of faces. These are the triangular pyramid or tetrahedron, cube or hexahedron, octahedron, dodecahedron and icosahedron.

The gaming machine may have the polyhedron as a cube, and the polyhedron may have at least three, at least four, at least six, at least eight or up to or even at least thirteen or eighteen axes of rotation usable in reorienting faces of the cube during play of the wagering game and multiple cubes are displayed and paylines that are defined along predetermined orientations of faces on multiple cubes.

The stop positions may include images of active symbols provided in formats selected from the group consisting of a single cube face, two cube faces and three cube faces, and at least one payline may include all symbols or less than all provided on faces in a predetermined order of cubes. The gaming system may have the processor configured to cause at least three virtual cubes to rotate simultaneously and/or to cause at least two cubes to appear to stop rotating simultaneously, and/or to cause at least two cubes to appear to stop rotating sequentially.

The gaming system may have paylines consist of only symbols displayed in like positions on exposed cube faces, or have paylines of symbols displayed in like and unlike positions on exposed cube faces. The wagering game may be a bonus event.

The electronic display device may be any electronic display system, as by non-limiting examples of one or more of a light-emitting diode (LED) display, a liquid crystal display (LCD), a plasma display, a vacuum fluorescent display (VFD), and multi-layer display (MLD). The gaming machine may have the processor configured to substantially continuously update said electronic display device, and the processor may be coupled to a plurality of electronic display devices, said processor is configured to update the plurality of electronic display device to reflect a respective award value.

The game may be initiated and events progress with numerous options available in design and performance. To begin the game, there may be standard play of manually touching an indicator (touchscreen, button, toggle, or the like) of an amount of a wager, a spin initiation or the like. There also may be contact with the virtual images of the polyhedrons to touch one or more individual symbols to start the revolution of the symbol or to stop the revelation of the symbols. A player may even swipe across the symbol in a direction of desired revolution of the symbol. The specific points of rotation of the polyhedrons may be selected by the player, may be automatically provided, or randomly provided. The selection may be done by selection of numbers of lines of play or selection of types of axes of rotation (e.g., about edges, about corners, about center of gravity, not about center of gravity, about middle of edges, etc.).

A gaming method includes accepting a wager made by a player of the gaming machine described herein, enabling play of a first game in which:

the processor recognizes a wager along a payline;

the processor identifies the payline as specific orientations of faces on the polyhedron.

At least some known gaming machines and/or gaming systems include various different types of symbol displays, paylines and display formats whether in an underlying game or in a bonus event. In some of such known machines and/or systems, spinning reels or otherwise randomly providing symbols for display enables the player to increase or decrease numbers and types of paylines that provide a payout that is defined within a paytable.

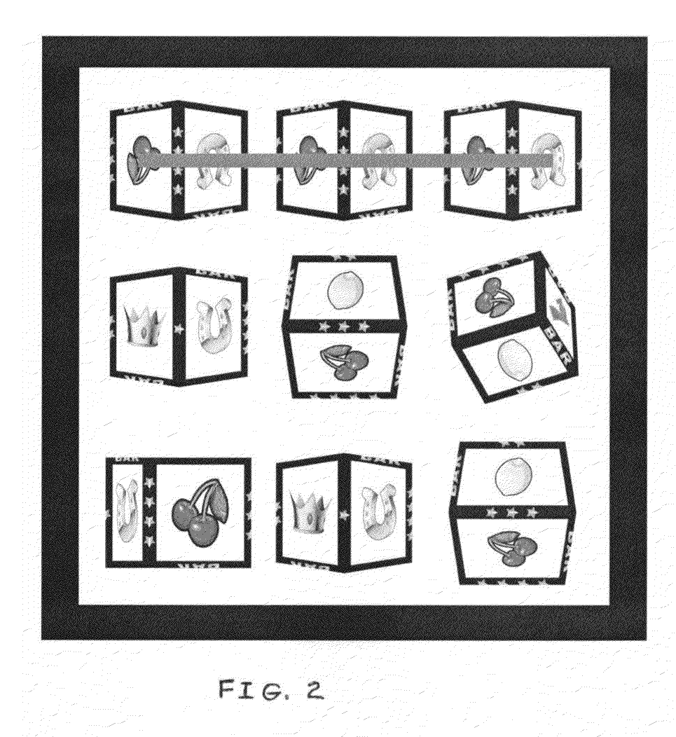

FIG. 2 shows a front view of a display screen image of nine cubes in an orientation wherein all three of the faces in only the far right column are in a same orientation. No other possible paylines have been formed by three same orientation faces. Note again that even though each cube has rotated about the virtual center of gravity, this is not necessarily essential, but is desirable.

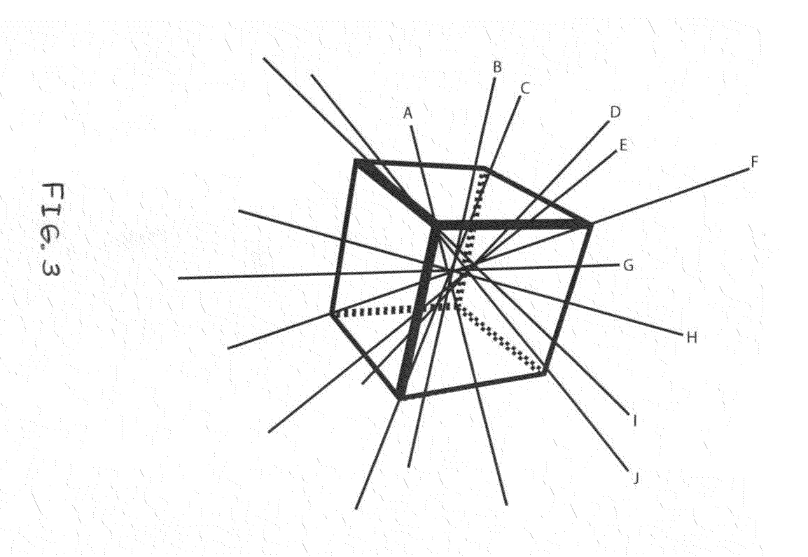

FIG. 3 shows a perspective view of a cube with each corner labeled (as A, B, C, D, E, F, G and H) and symbols displayed on the three forward-looking faces of the cube. Although later figures and discussions provide descriptions of many available axes of rotation for any individual cube, this figure provides a general basis for describing some if not all possible axes of rotation. Looking at the cube and its identified corners, among the clearly apparent axes would be rotations along lines connecting corners A-B, B-C, C-E, E-A, A-F, B-D, C-H, E-G; F-D, D-F, G-H and G-F. There are also axes that are fairly clear between corners A-H, B-G, C-F and D-E, as well as B-F, A-D, E-H, and C-G, as well as E-F, B-H, C-D, and A-G. In addition to these rigid lines with axes defined between two corners (as all of which are defined above), the cubes may revolve along axis that shift the virtual center of gravity of the virtual cube, as by rotating around corner A, with any of the seven other corners (from their original position as shown) defining a start and finish point for a circular rotation about corner A. Each of the other corners may also be fixed and other corners used to assist in defining axes of rotation that shift the position of the virtual center of gravity (the point where lines between opposed corners (e.g., A-H, B-G, C-F and D-E in FIG. 3) cross.

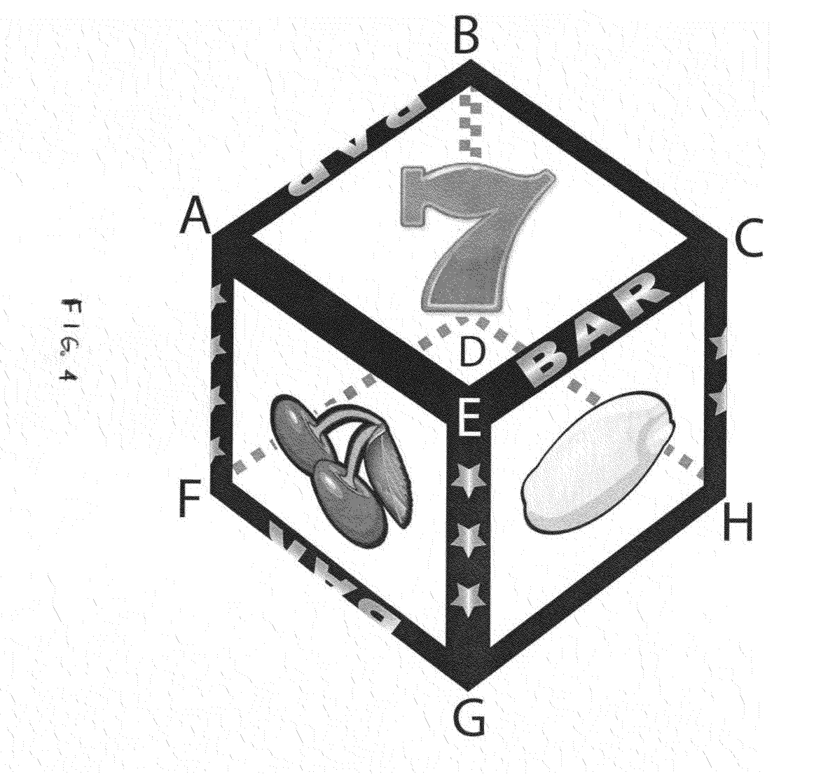

FIG. 4 shows a perspective view of a cube with ten (as A, B, C, D, E, F, G, H, I and J) non-side axes of rotation displayed. Some of these axes of rotation keep the virtual center of gravity fixed (e.g., C, F, H and J), while others (e.g., E and I) allow movement of the virtual center of gravity. This shows that there is, in theory, there are a potential infinite number of axes, but rational design will use geometrical meaningful points for defining the axes of rotation, such as corners or middle of edges.

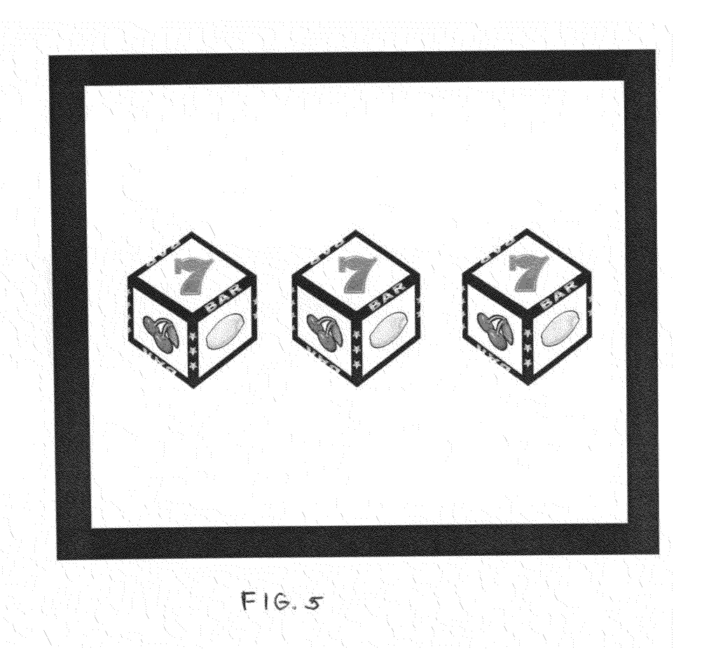

FIG. 5 shows a front view of a display screen image of three cubes in an orientation wherein all three of the faces are in a same orientation. It is to be easily visualized from this image that there are three possible matching paylines (through the faces with the “7s” thereon, the faces with the cherries thereon and the faces with the lemons thereon. The fact that images match does not mean that there is a winning outcome on the payline (e.g., three lemons), but the three faces are each in alignment on all three cubes. It is also to be noted that in the practice of the present technology, images do not have to oriented identically to form a match as long as the images (symbols) combine to form winning outcomes. Looking at this figure, for example, if the cube is rotated 90 degrees about an axis formed by a line passing perpendicularly through the center of the face of the first cube with the 7 on it, the seven on that cube would remain on a face remaining on the same plane and orientation as the other two cubes, but the 7 would not be oriented in the same direction (it would be rotated 90 degrees) as the other two 7s on the other two cubes. This also offers a potential variation in paylines that is novel where orientation of symbols is another consideration in odds and payouts along a payline. That is, even with three 7s (or any other symbol) present along the payline, where there are no similarly aligned 7s, where there are two similarly aligned 7s (symbols) on a payline, and where there are three similarly aligned 7s (symbols) along a payline, and even the type of alignment (vertical, angles or upside-down) may further alter odds or payouts in winning combinations of symbols or define jackpots or bonus entry outcomes.

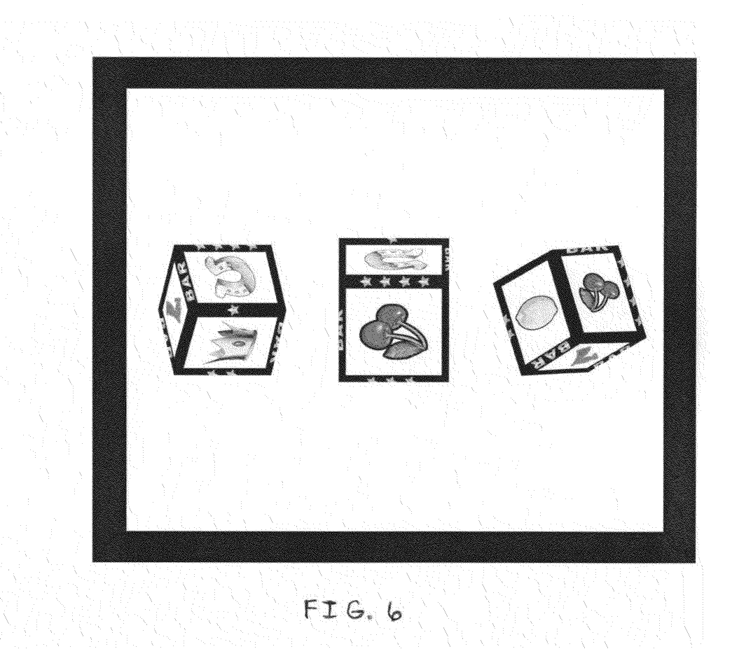

FIG. 6 shows a front view of a display screen image of three cubes in an orientation wherein all three of the faces are in different orientations with no available paylines according to some modalities of game play where only same orientations may form paylines. Note that even though each cube has rotated about the virtual center of gravity, this is not necessarily essential, but is desirable.

This description is provided to introduce a selection of concepts in a simplified form that are further described below in the Detailed Description. This Brief Description is not intended to identify key features or essential features of the claimed subject matter, nor is it intended to be used as an aid in determining the scope of the claimed subject matter.

In one aspect, a gaming machine is provided, including a memory, a first display device configured to display a first game, a second display device configured to display a second game, and a processor coupled to the memory, the first display device, and the second display device. The second display device includes a plurality of segments, wherein at least one of the segments is an electronic display device. The processor is configured to enable play of the first game in response to a wager made by the player, enable play of the second game upon detection of a triggering event during play of the first game, and during play of the first game and the second game, update the electronic display device to reflect a current award value.

In another aspect, a gaming machine is provided, including a memory, a rotatable display device that includes a plurality of segments, and a processor coupled to the memory and the rotatable display device. At least one of the segments of the rotatable display device is an electronic display device. The processor is configured to enable play of a first game based on a wager made by a player, detect a triggering event during play of the first game, enable play of a second game based on the detection of the triggering event, and during play of the first game and the second game, update the electronic display device to reflect a current award value of a progressive game.

In another aspect, a gaming method is provided that includes accepting a wager made by a player of a gaming machine, enabling play of a first game using the gaming machine, wherein the first game is display using a first display device, and detecting a triggering event during play of the first game. Play of a second game using the gaming machine is enabled upon detection of the triggering event, wherein the second game is displayed using a second display device having a plurality of segments. At least one of the segments is an electronic display device. During play of the first game and the second game, the electronic display device is updated to reflect a current award value.

In yet another aspect, a gaming system is provided that includes a plurality of gaming machines, a shared display configured to display a second game, and a controller coupled to the gaming machines and the shared display. Each gaming machine configured to display a first game, and the shared display includes a plurality of segments, wherein at least one of the segments is an electronic display device. The controller is configured to detect a triggering event during play of the first game on at least one of the gaming machines, enable play of the second game upon detection of the triggering event, and during play of the first game and the second game, update the electronic display device to reflect a current award value.

In another aspect, a gaming method is provided, including accepting a wager made by a player using at least one of a plurality of gaming machines, enabling play of a first game using the gaming machines, and detecting a triggering event during play of the first game. The method also includes enabling play of a second game, wherein the second game is displayed using a shared display having a plurality of segments. At least one of the segments is an electronic display device. The method also includes during play of the first game and the second game, updating the electronic display device to reflect a current award value.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Technical effects of methods, systems, and apparatus described herein include at least one of (a) accepting a wager by a player using a gaming machine; (b) enabling play of a first game using the gaming machine, wherein the first game is displayed using a first display device; (c) determining an outcome of the first game; (d) awarding the player if the outcome of the first game is a winning outcome; (e) determining whether the outcome of the first game includes a triggering event; (f) if the outcome of the first game includes a triggering event, initiating play of a second game using a second display device, wherein the second display device includes a plurality of segments, at least a portion of which are electronic display devices configured to update, such as continuously update, a respective award value; and (g) awarding the player based on an outcome of the second game.

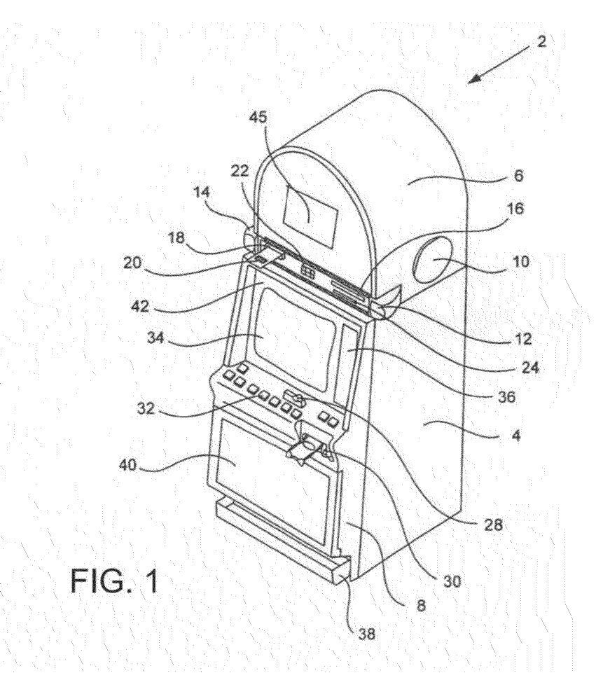

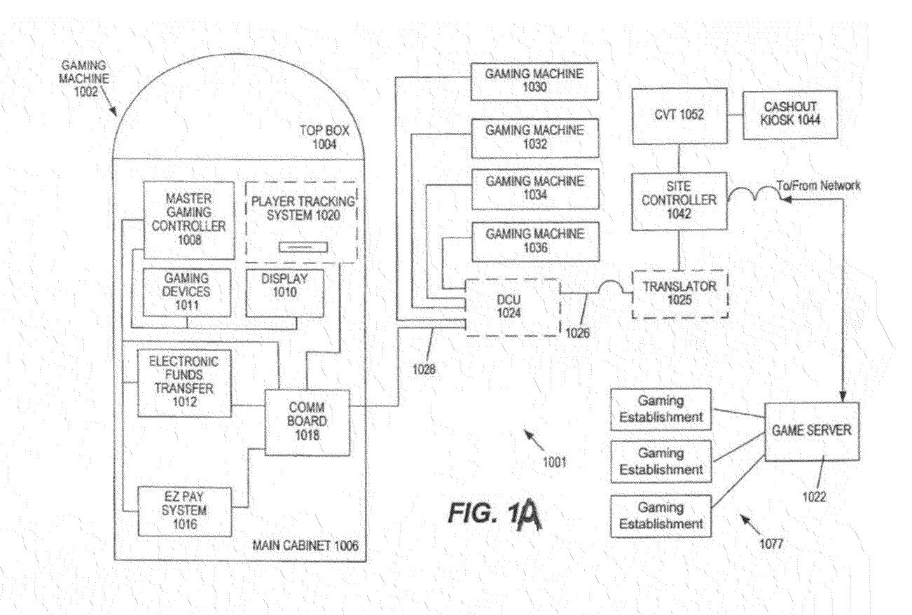

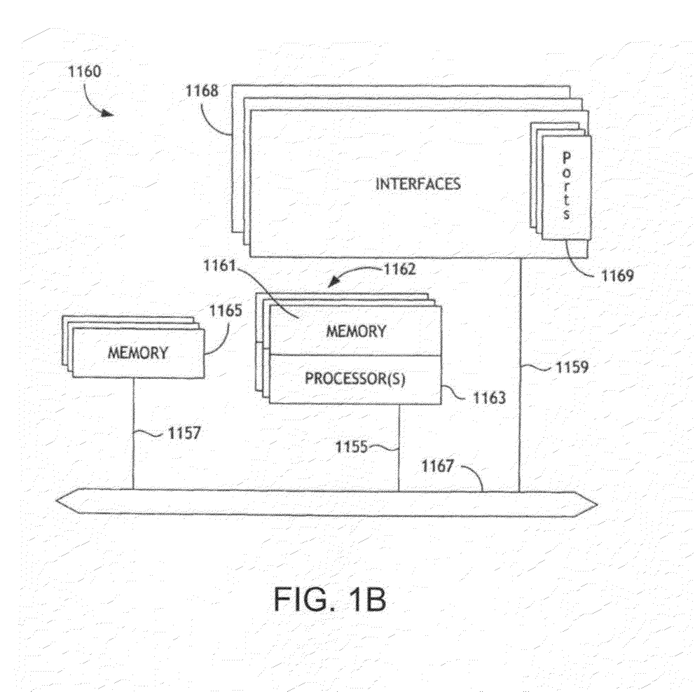

Turning next to FIG. 1, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play. The graphics may be two-dimensional graphics that represent the symbols of polyhedrons in pseudo-three-dimensions, or the image graphics and display system may be actual three-dimension displays or holograms (e.g., such as in Published US Patent Application Documents Nos. 20120050687, 20110149249, 20100134695 and 20070201004).

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in IGT gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog tinier always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 from U.S. patent application Ser. No. 09/925,098, filed Aug. 8, 2001 and titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Gaming Networks—Many implementations of the present invention may advantageously be practiced via a gaming machine network. Some such networks are described in U.S. patent application Ser. No. 11/225,407, by Wolf et al., entitled “METHODS AND DEVICES FOR MANAGING GAMING NETWORKS” and filed Sep. 12, 2005, which is incorporated herein by reference in its entirety and for all purposes.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022.

Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above in FIGS. 6 and 7. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system 1016 (a proprietary cashless ticketing system of the present assignee), and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

Some methods of the invention combine information that can be obtained from game network accounting systems with features described above. By combining, for example, information regarding scheduled gaming machine configurations and information regarding the amount of money that a gaming machine brings in while a gaming machine has a particular configuration, gaming machine configurations may be optimized to maximize revenue. Some such methods involve determining a first rate of revenue obtained by a gaming machine in the gaming network during a first time when the gaming machine has a first configuration. The gaming machine is later automatically configured according to second configuration information supplied by the SBG server, e.g., as scheduled by the Scheduler. A second rate of revenue, obtained by the gaming machine during a second time when the gaming machine has the second configuration, is determined, and so on.

After scheduling various configurations at various times, optimum configurations for the gaming machine may be determined for various times of day. The SBG system can them provide scheduled optimal configurations for the gaming machine at the corresponding times of day. Some implementations provide for groups (e.g., banks) of gaming machines to be automatically configured according to a predetermined schedule of optimal configurations for various times of day, days of the week, times of the year, etc.

In some such implementations, an average revenue may be computed, based on revenue from many gaming machines having the same configuration at the same time of day. These average revenues could be used to determine an overall optimal value for relevant time periods.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1A illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

What is claimed:

1. A gaming machine comprising: a processor; a memory; player input controls; an electronic display device configured to display a wagering game; said display device configured to display, after recognition of a wager being placed through a player input control, images from the memory displaying simulations of multiple symbols of polyhedrons, each polyhedron having axes of rotation about predetermined axes of revolution within or on the polyhedron; memory providing stop positions for display of faces for forming paylines in a wagering games, the paylines including fully displayed faces and multiple faces simultaneously displayed at the stop position; wherein the electronic display device is configured to display from the memory a simulated rotation about the axes of rotation according to:
c) a random selection by the processor of an axis of rotation for at least one symbol providing polyhedron or
d) player input control selected axis of rotation for the at least one symbol providing polyhedron;
the processor configured to resolve the recognized wager based upon comparison of the displayed simulations of multiple paylines provided along faces of the at least one symbol providing polyhedron against a paytable.

2. The gaming machine of claim 1 wherein the axes of rotation are selected from axes that pass through a virtual geometric center of gravity of the polyhedron.

3. The gaming machine of claim 1 wherein the axes of rotation are selected from axes that do not pass through a virtual geometric center of gravity of the polyhedron.

4. The gaming machine of claim 1 wherein the axes of rotation pass through two corners of the polyhedron.

5. The gaming machine of claim 1 wherein the axes of rotation pass through only one corner of the polyhedron.

6. The gaming machine of claim 2 wherein the polyhedron comprises a cube.

7. The gaming machine of claim 4 wherein the polyhedron comprises a cube.

8. The gaming device of claim 6 wherein the polyhedron has up to thirteen axes of rotation usable in reorienting faces of the cube during play of the wagering game and multiple cubes are displayed and paylines are defined along predetermined orientations of faces on multiple cubes.

9. The gaming device of claim 6 wherein the stop positions include images of active symbols provided in formats selected from the group consisting of a single cube face, two cube faces and three cube faces.

10. The gaming device of claim 7 wherein at least one payline includes all symbols provided on faces in a predetermined order of cubes.

11. The gaming device of claim 7 wherein at least one payline includes less than all symbols in a predetermined order of cubes.

12. The gaming system of claim 6 wherein the processor is configured to cause at least three virtual cubes to rotate simultaneously.

13. The gaming system of claim 6 wherein the processor is configured to cause at least two cubes to appear to stop rotating simultaneously.

14. The gaming system of claim 12 wherein the processor is configured to cause at least two cubes to appear to stop rotating sequentially.

15. The gaming system of claim 6 wherein paylines consist of only symbols displayed in like positions on exposed cube faces.

16. The gaming system of claim 6 wherein paylines comprise symbols displayed in like and unlike positions on exposed cube faces.

17. A gaming system in accordance with claim 1, wherein said wagering game comprises a bonus event.

18. A gaming machine in accordance with claim 1, wherein said electronic display device comprises one of a light-emitting diode (LED) display, a liquid crystal display (LCD), a vacuum fluorescent display (VFD), and multi-layer display (MLD).

19. A gaming machine in accordance with claim 1, wherein said processor is configured to substantially continuously update said electronic display device.

20. A gaming machine in accordance with claim 6, wherein said processor is coupled to a plurality of electronic display devices, said processor is configured to update the plurality of electronic display device to reflect a respective award value.

21. A gaming method comprising: accepting a wager made by a player of the gaming machine of claim 1, enabling play of a first game in which:
the processor recognizes a wager along a payline;
the processor identifies the payline as specific orientations of faces on the polyhedron.
